(19) United States
(12) Patent Application Publication
(10) Pub. No.: US 2012/0174416 A1
(43) Pub. Date: Jul. 12, 2012

(54) ELECTRIC PRUNING DEVICE

(75) Inventor: William J. Nelson, II, Solon, OH (US)

(73) Assignee: CI, LLC

(21) Appl. No.: 13/287,514

(22) Filed: Nov. 2, 2011

Related U.S. Application Data
(60) Provisional application No. 61/430,609, filed on Jan. 7, 2011.

(51) Int. Cl. A01G 3/053

(52) U.S. Cl. 30/276

(57) ABSTRACT

A cutting tool for cutting vegetation including a rotary cutting bit adapted to be advanced through the vegetation in a direction perpendicular to the bit's axis of rotation. The tool can include a guard member at least partially surrounding the rotary cutting bit. The guard member can be biased towards a first portion and pivotable to a second position during a cutting operation. The rotary cutting bit can be supported by two bit supports spaced apart axially. A removable handle and shield member can also be provided.

This application claims priority from U.S. provisional application Ser. No. 61/430,609, filed Jan. 7, 2011, entitled “ELECTRIC PRUNING DEVICE”, which application is incorporated by reference herein in its entirety.

### BACKGROUND

The present exemplary embodiment relates to a pruning device for pruning vegetation. It finds particular application in conjunction with a device for trimming limbs of a tree, and will be described with particular reference thereto. However, it is to be appreciated that the present exemplary embodiment is also amenable to other like applications.

Pruning devices are generally used to cut branches and limbs of trees and bushes. Basic pruning devices generally include a saw or shears for such cutting. In the case of a saw, a user engages the saw blade with a branch to be cut, and then saws through the branch using a reciprocating motion. In the case of shears, the user aligns the jaws of the shear with a branch to be cut, and then snips the branch by manipulating the handles of the shears. Powered pruners include chainsaws and hedge trimmers.

Known prior art pruning devices have been found to be either difficult to operate due to weight and/or size, produce imprecise cuts, and/or require two hands to operate effectively which can make pruning dangerous. For example, falling from ladders and trees is a leading cause of injury and/or death when pruning trees. In addition, people are injured or killed every year when using chainsaws to prune and/or cut down small trees. Such injuries and fatalities may be due at least in part to using a pruning device that requires two hands to operate, thus preventing the operator from using a free hand to aid in balancing his or her body.

In addition, since most existing pruners require two-handed operation, it can be difficult to move branches out of the way when pruning. Men and especially women may have a difficult time using pruning shears and loppers because the tools require substantial upper-body strength to operate. Professional landscapers may experience fatigue and/or tendonitis when performing pruning of trees and shrubs and sawing of small trees. Pruning with existing devices can take a long time, thus decreasing landscapers profits and/or increasing the costs to consumers. Existing pruning and cutting devices are not only inefficient, they also require significant attention to safety to operate in a safe manner.

### BRIEF DESCRIPTION

In accordance with one aspect, a cutting tool for cutting vegetation comprises a housing, a motor supported within the housing, an output shaft operatively connected to the motor for rotating an associated rotary cutting bit, and a guard member attached to the housing and extending in a common direction with the output shaft, the guard member having two side portions and a curved portion forming a general U-shape, the guard member being pivotally attached to the housing. The guard member is pivotable between a first position whereat each side portion of the guard member extends generally parallel and spaced apart from a longitudinal axis of the output shaft, and a second position whereat each side portion of the guard member extends generally non-paralled and spaced apart from the longitudinal axis of the output shaft. When an associated rotary cutting bit is operatively connected to the output shaft, the side portions of the guard member, when in the first position, extend along a length of the associated cutting bit.

The guard member can include a plurality of teeth along at least one edge. The teeth can be angled away from the curved portion of the guard member and, when engaged with a surface of associated vegetation, can tend to resist sliding movement of the tool relative to the associated vegetation. The tool can further include a biasing member, such as a spring, for biasing the guard member towards the first position. The motor can be any type of motor including an electric motor, a pneumatic motor, and/or a hydraulic motor. A handle can be provided that is removably attachable to the housing. In addition, a shield member can be provided that is removably attachable to the housing and configured to at least partially surround the associated cutting bit when the associated bit is operatively connected to the output shaft. The shield member can include a concave surface facing the associated cutting bit when the associated bit is operatively connected to the output shaft.

In an exemplary embodiment, the motor is an electric motor, and the tool further includes a battery operatively connected to the electric motor for supplying electric power thereto. The housing includes a pistol grip and a trigger switch is provided for controlling the motor.

In accordance with another aspect, a cutting tool for cutting vegetation comprises a housing, a motor supported within the housing, an output shaft operatively connected to the motor for rotating an associated rotary cutting bit, a power source is operatively connected to the motor for supplying power to the motor, and first and second spaced apart bit supports for supporting the associated rotary cutting bit for rotation at spaced apart locations along a longitudinal axis of the associated rotary cutting bit, at least one of the bit supports being supported by the housing.

At least one of the bit supports can include a collet for engaging a shank of the associated rotary cutting bit, the collet being fixed for rotation with the output shaft. The at least one bit support supported by the housing can include a bit support arm secured to the housing. The tool can further include a guard member attached to the housing and extending in a common direction with the output shaft, the guard member having two side portions and a curved portion forming a general U-shape, at least one of the side portions being pivotally attached to the housing. The guard member can be pivotable between a first position whereat each side portion of the guard member extends generally parallel and spaced apart from a longitudinal axis of the output shaft, and a second position whereat each side portion of the guard member extends generally non-parallel and spaced apart from the longitudinal axis of the output shaft. When an associated rotary cutting bit is operatively connected to the output shaft, the sides of the U-shape guard, when in the first position, can extend along a length of the associated rotary cutting bit.

The bit support arm can extend from the housing generally parallel with the rotary cutting bit, and the bit support arm can have a thickness that is at least as large as the diameter of the rotary cutting bit such that the bit support arm acts as a spreader for a cut made in associated vegetation by the rotary cutting bit. At least one of the bit supports can include a bearing for supporting the associated rotary cutting bit for rotation. The housing can include a pistol grip portion, and a trigger switch can be provided for controlling the electric motor.

### BRIEF DESCRIPTION OF THE DRAWINGS

FIG. 1 is a perspective view of an exemplary tool in accordance with a first embodiment of the present disclosure;

FIG. 2A is side elevational view of the tool of FIG. 1 with its guard member shown in a first position;

FIG. 2B is a side elevational view of the tool of FIG. 1 with its guard member shown in a second position;

FIG. 3 is a perspective view of the tool of FIG. 1 with a portion of its housing removed to show internal components;

FIG. 4 is a side elevational view of another exemplary tool in accordance with a second embodiment of the present disclosure;

FIG. 5 is a perspective view of yet another exemplary tool having a removable handle and shield member in accordance with a third embodiment of the present disclosure;

FIG. 6 is a perspective view of the tool of FIG. 5 with the removable handle and shield member attached to the housing of the tool; and

FIG. 7 is a side elevational view of still another exemplary tool in accordance with a fourth embodiment of the present disclosure.

### DETAILED DESCRIPTION

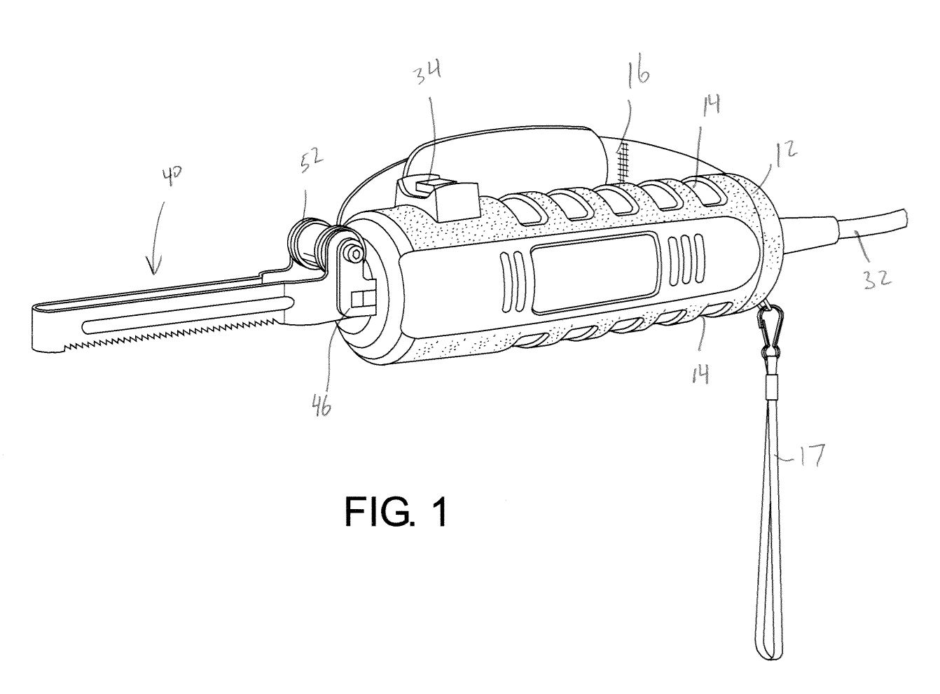

With reference to FIG. 1, an exemplary cutting tool for cutting vegetation in accordance with the disclosure is illustrated and identified generally by reference numeral 10. The cutting tool 10 has a generally cylindrical housing 12 that can include a rubber outer surface having a plurality of finger grips 14 designed to assist a user in grasping the tool 10 during operation. An adjustable hand strap 16 is secured to the housing 12 and provides additional grip security. The hand strap 16 can be adjusted to snugly fit virtually any size hand, and is designed to rotate to accommodate both left and right hand use, and can be removable for washing. A wrist strap 17 is also provided for tethering the tool 10 to an operator's wrist.

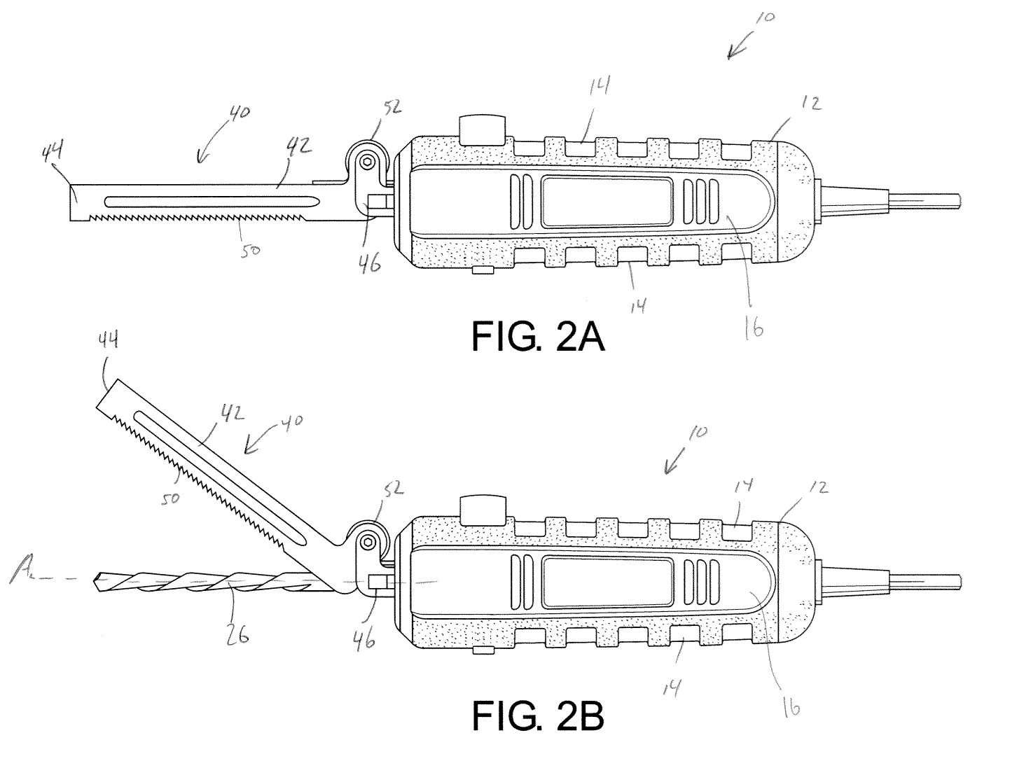

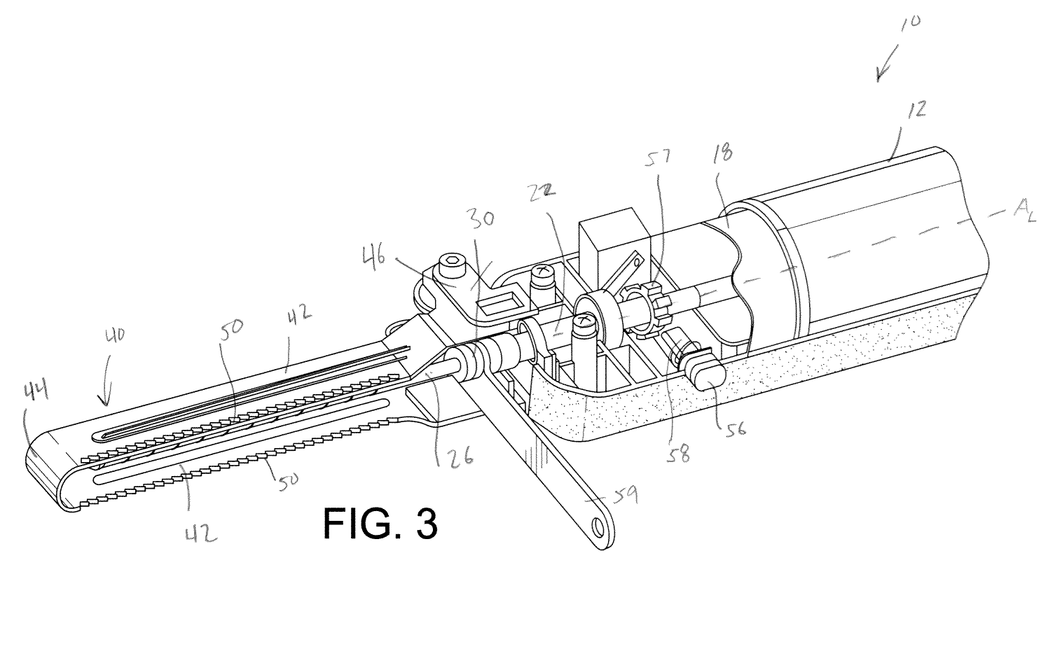

With additional reference to FIGS. 2A, 2B and 3, the cutting tool 10 includes a motor 18 supported within the housing 12. An output shaft 22 is operatively connected to the motor 18 for rotating a rotary cutting bit 26. The rotary cutting bit 26 is connected to the output shaft 22 by a collet 30 secured to the output shaft 22. The collet 30 is designed to grasp a shank portion of the rotary cutting bit 26 thereby securing a rotary cutting bit 26 to the output shaft 22 for rotation therewith. The cutting bit 26 can be a fluted bit designed to spin at up to 35,000 RPM. The high speed rotation produces a clean straight and even cut through a variety of vegetation.

In the embodiment of FIGS. 1-3, the cutting tool 10 is an electric cutting tool and receives electrical power via an electric cord 32 that supplies electrical power to the motor 18 from a wall outlet, generator or other power source. A switch 34 is provided for controlling the operation of the motor 18. The switch 34 can be a simple on/off switch wherein when the switch 34 is depressed or otherwise activated, the electric motor 18 is switched on thereby rotating the rotary cutting bit 26. The switch 34 can also be a variable switch wherein the speed of the motor 18 is controlled as a function of the degree to which the switch is activated. In either case, the switch 34 can be biased to its off position such that the tool 10 is only switched on when the switch 34 is actively depressed by the operator. Should the tool be dropped or the operator's finger otherwise releases the switch 34, the tool 10 will switch off thereby stopping the rotary cutting bit and preventing injury or damage.

Secured to the housing 12 is a guard member 40 that extends in a common direction with the output shaft 22 and, in this embodiment, in a common direction with the rotary cutting bit 26. The guard member 40 has two side portions 42 that are connected together by a curved portion 44 thus giving the guard member 40 a general u-shape. Each side portion 42 of the guard member 40 is pivotally secured to respective guard member support arms 46 extending from the housing 12. The guard member support arms 46 are generally L-shape and provide a point of attachment for the guard member 40 that is spaced apart axially from the rotational axis of the output shaft 22 A_{L}. The guard member 40 can alternatively be secured directly to the housing 12.

The guard member 40 is pivotable between a first position (FIG. 2A) whereat each side portion 42 of the guard member 40 extends generally parallel and spaced apart radially from the longitudinal axis A_{L} of the output shaft 22, and a second position (FIG. 2B) whereat each side portion 42 of the guard member 40 extends generally non-parallel and spaced apart radially from the longitudinal axis A_{L} of the output shaft 22. As will be appreciated, the axially offset location of attachment of the guard member 40 to the guard member supports 46 facilitates pivoting of the guard member 40 completely clear of the rotary cutting bit such that the entire length of the bit can be utilized during a cutting operation.

In operation, a user will typically grasp the housing 12 and place the cutting tool 10 into contact with vegetation to be cut. More particularly, a user can place the guard member 40 in contact with a surface of the vegetation, such as a tree limb, and then activate the motor 18 at which time the rotary cutting bit 26 can be advanced through the vegetation. As the rotary cutting bit 26 is advanced through the vegetation, the guard member 40 is pivoted from the position shown on FIG. 2A to a position such as the position shown in FIG. 2B by contact with the vegetation.

To assist an operator in aligning the rotary cutting bit 26 with vegetation to be cut, the guard member 40 includes a plurality of teeth 50 on each side portion 42. The teeth 50 are angled towards the housing 12 of the tool 10 (away from the curved portion 44). Accordingly, the teeth 50 tend to resist sliding movement of the tool 10 relative to the vegetation. The effect of the teeth 50 can be to assist not only in aligning the rotary cutting bit 26 prior to the start of a cutting operation, but also to stabilize the tool 10 during a cutting operation.

The guard member 40 in the illustrated embodiment is biased towards the position shown in FIG. 2A. To this end, a biasing member in the form of spring 52 is interposed between the guard member 40 and the housing 12 so as to apply a biasing force that tends to urge the guard member 40 into alignment with the rotary cutting bit 26. It will be appreciated that the guard member 40, when in the position shown in FIG. 2A, prevents or reduces the potential for contact between the rotary cutting bit 26 and foreign objects. Accordingly, the guard member 40 is generally maintained in such position except during cutting operations to prevent unwanted contact of the rotary cutting bit 26 with the operator and/or other objects to which the rotary cutting bit 26 may cause damage.

With reference to FIG. 3, it will be appreciated that the cutting tool 10 can be provided with a output shaft lock mechanism 56 that is configured to lock the output shaft 26 against rotation when depressed. The output shaft lock mechanism 56 includes a cog wheel 57 fixed to the output shaft 26 and a lock pawl 58 moveable to engage the cog wheel 57 to restrict rotation of the output shaft 26. The output shaft lock mechanism 56 can be useful when loosening collet 30 such as with a wrench 59 for replacing the rotary cutting bit 26.

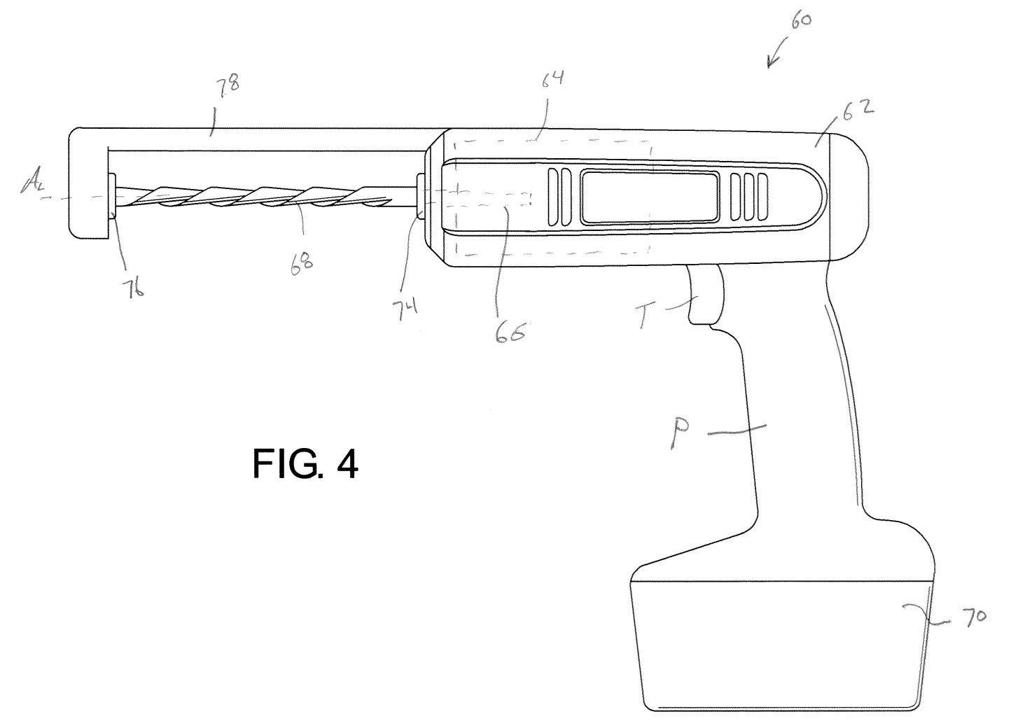

Turning now to FIG. 4, another exemplary embodiment of a cutting tool in accordance with the disclosure is illustrated and identified generally by reference numerals 60. In this embodiment, the cutting tool is a cordless cutting tool and includes a housing 62, a motor 64 supported within the housing 62, an output shaft 66 operatively connected to the motor 64 for rotating a rotary cutting bit 68, and a battery 70 supported by the housing 62 and operatively connected to the motor 64 for supplying power thereto. In one embodiment, the tool 60 can be a modified cordless tool such as a cordless drill, for example, and includes a pistol grip P and a trigger switch T. First and second spaced apart bit supports are provided for supporting the rotary cutting bit 68 for rotation. In the illustrated embodiment, a bit support in the form of a collet 74 is supported on the output shaft 66 and is configured to engage a shank portion of the rotary cutting bit 68. The second bit support includes a bearing 76 supported on a bit support arm 78 that is in turn supported by housing 62. Bearing 76 is adapted to receive the distal end of the rotary cutting bit 68 such that, along with collet 74, the rotary cutting bit 68 is supported for rotation at two locations that are spaced apart along the longitudinal axis A_{L} of the rotary cutting bit 68.

By supporting the rotary cutting bit 68 at each end, a stabilizing effect is achieved wherein the rotary cutting bit 68 may operate more smoothly and/or experience less flexure during a cutting operation. In addition, bearing 76 allows the use of longer rotary cutting bits, such as for cutting larger diameter vegetation (tree limbs, palm fronds, etc.). For example, rotary cutting bits of 3 to 20 inches or longer can be utilized.

In the illustrated embodiment, bit support arm 78 is sized such that it can freely pass through a cut made by a rotary cutting bit 68. To this end, the bit support arm 78 will generally have a width (e.g., measured in a dimension normal to the plane of FIG. 4) that is less than a diameter of the rotary cutting bit 68. Thus, as the rotary cutting bit 68 is advanced through a tree limb or the like and creates a cut therein, the bit support arm 78 having can also freely pass through the limb via the cut made by the rotary cutting bit 68.

In another embodiment, the bit support arm 78 acts as a spreader to prevent a limb being cut from closing on the bit and binding the tool. In such configuration, the bit support arm 78 can have a width dimension that is equal to or larger than the diameter of the rotary cutting bit. In addition, the bit support arm 78 can be wedge shaped to urge the limb apart during a cutting operation.

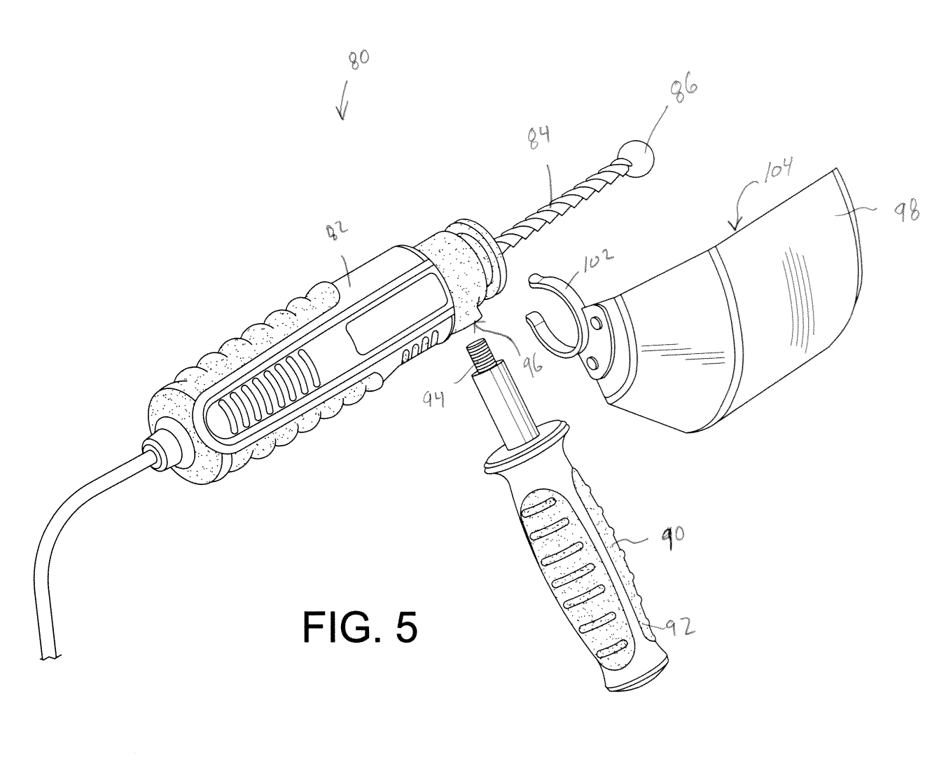

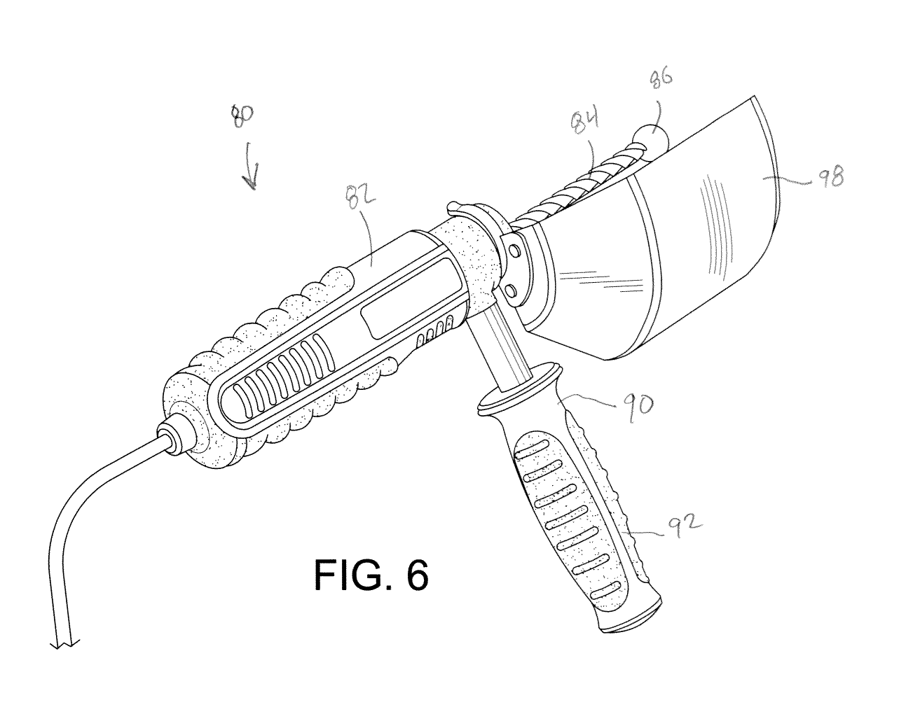

Turning to FIGS. 5 and 6, another exemplary tool 80 in accordance with the disclosure is illustrated. The tool 80 may be similar to the tool 10 shown and described in connection with FIGS. 1-3 and generally includes a housing 82 in which a motor is supported. An output shaft is operatively connected to the motor and extends from the housing 82 for connection with the rotary with a rotary cutting bit 84. In this embodiment, the rotary cutting bit 84 has a spherical terminal end 86 which may assist an operator during a cutting operation in determining whether the rotary cutting bit 84 has advanced completely to an opposite side of a given piece of vegetation.

In the embodiment of FIGS. 5 and 6, a handle 90 is provided. The handle 90 has a grip portion 92 and a threaded shaft portion 94 that is adapted to be threaded into a corresponding threaded bore 96 within the housing 82. As will be appreciated, the handle 90 can be optionally attached to the housing 82 as desired, such as when additional leverage is needed for a particular cutting operation. Other attachment mechanisms could be provided for securing the handle 90 to the housing 82.

Also in this embodiment, a shield member 98 is provided. The shield member 98 is configured to be releasably attached to the housing 82 of the tool 80. A clip member 102 is provided for securing the shield member 98 to the housing 82. When installed, the shield member 98 partially surrounds the cutting bit 84. A concave inner surface 104 of the shield member 98 faces the cutting bit and can be adapted to deflect sawdust, shavings, and other cutting debris away from an operator during a cutting operation.

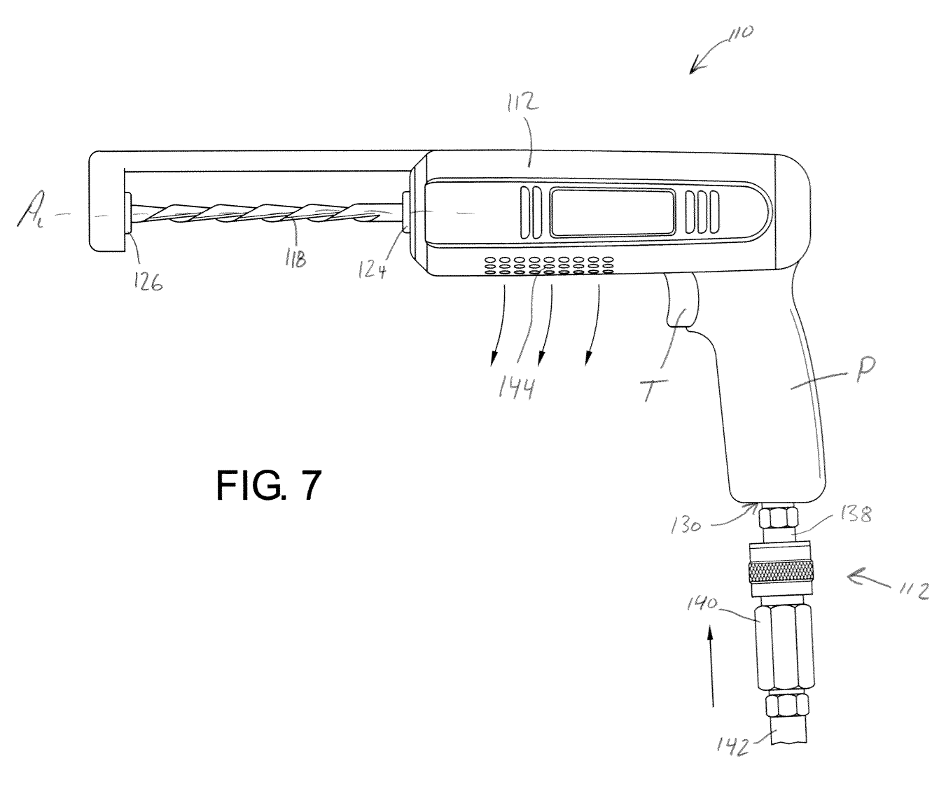

Turning to FIG. 7, an exemplary pneumatically powered cutting tool is illustrated and generally identified by reference numeral 110. In this embodiment, the cutting tool 110 is similar to the cutting tool 60 of FIG. 4 except that cutting tool 110 is air-powered instead of battery operated. The cutting tool 110 includes a housing 112, a pneumatic motor supported within the housing 112 and an output shaft operatively connected to the motor for rotating a rotary cutting bit 118. The pneumatic motor and output shaft are not visible in FIG. 7, but can be arranged in a similar manner within the housing 112 as the motor and output shaft of the embodiment shown and described in connection with FIG. 4.

The cutting tool 110 includes a pistol grip P and a trigger switch T for controlling the flow of pressurized air to the pneumatic motor. First and second spaced apart bit supports are provided for supporting the rotary cutting bit 118 for rotation. In the illustrated embodiment, a bit support in the form of a collet 124 is supported on the output shaft and is configured to engage a shank portion of the rotary cutting bit 118. The second bit support includes a bearing 126 supported on a bit support arm 128 that is in turn supported by housing 112. Bearing 126 is adapted to receive the distal end of the rotary cutting bit 118 such that, along with collet 124, the rotary cutting bit 118 is supported for rotation at two locations that are spaced apart along the longitudinal axis AL of the rotary cutting bit 118.

The cutting tool 110 further includes an air inlet 130 for receiving compressed air from a compressed air source such as an air compressor (not shown). In the illustrated embodiment, a quick-connect coupling is provided for enable quick connection and disconnection of the cutting tool 110 to a compressed air source. The quick-connect coupling 136 includes a nipple or plug portion 138 associated with the cutting tool 110, and a female coupling portion 140 associated with a supply hose 142 that is adapted to mate with the plug portion 138. Of course, any suitable coupling device or method can be used for supplying compressed air to the cutting tool 110.

Compressed air is delivered through the housing 112 to the pneumatic motor via one or more passageways within the housing 112. As mentioned above, the trigger switch T can control the flow of compressed air to the pneumatic motor. To this end, the trigger switch T can be configured to actuate a suitable valve to control air flow to the pneumatic motor. Exhaust air exits the housing via exhaust vent 144. As will be appreciated, rotary pneumatic tools and devices are well known and, therefore, the internal pneumatic features of the exemplary cutting tool 110 are only briefly summarized above.

As a further alternative, a hydraulically powered tool is also contemplated. Since hydraulically powered tools are well known, this embodiment is not illustrated herein, but could be similar to the pneumatically powered tool shown in FIG. 7.

It will now be appreciated that the exemplary embodiments disclosed herein set forth a tree trimming device or pruner that is easy to operate even with one hand. Unlike many prior art pruning devices, the devices of the present disclosure can be operated with a single hand thus leaving an operator's other hand free for stabilizing a branch to be cut, or for balancing the operator. This is of particular benefit when a user is attempting to trim vegetation while standing on a ladder or other elevated platform as it allows the user to maintain a balancing grip with one hand while operating the tool with the other hand.

Unlike pruning shears that can bind when on flexible vegetation, the disclosed tree trimming device will not bind. The tool is also lightweight and can greatly reduce tree trimming time by as much as 70%, for example. This can increase profits to landscapers and other laborers by allowing the scheduling of additional jobs without having to add additional employees. The disclosed tree trimming device can also reduce fatigue and injuries as compared to prior art devices.

Another potential use of the disclosed devices is for trimming lumber and other materials on a jobsite. In the past, a carpenter or other tradesman might typically cut all lumber at a cutting station and then carry the lumber to the location on the project where it is needed. Once the lumber is cut and moved to the location, it is cumbersome to return the lumber to the cutting station if the need arises to recut the board. The trimming device disclosed herein can be used by a carpenter to trim lumber on the spot, without having to return to the cutting station.

The exemplary embodiments have been described with reference to the preferred embodiments. Modifications and alterations can occur to others upon reading and understanding the preceding detailed description. It is intended that the exemplary embodiments be construed as including all such modifications and alterations insofar as they come within the scope of the appended claims or the equivalents thereof. In addition, it will be appreciated that various features of the different embodiments disclosed herein are interchangeable and/or combinable with other embodiments and/or features thereof.

1. A cutting tool for cutting vegetation comprising:
a housing;
a motor supported within the housing;
an output shaft operatively connected to the motor for rotating an associated rotary cutting bit; and
a guard member attached to the housing and extending in a common direction with the output shaft, the guard member including two side portions and a curved portion forming a general U-shape, the guard member being pivotally attached to the housing;
wherein the guard member is pivotable between a first position whereat each side portion of the guard member extends generally parallel and spaced apart from a longitudinal axis of the output shaft, and a second position whereat each side portion of the guard member extends generally non-paralled and spaced apart from the longitudinal axis of the output shaft;
whereby when an associated rotary cutting bit is operatively connected to the output shaft, the side portions of the guard member, when in the first position, extend along a length of the associated cutting bit.

2. A cutting tool as set forth in claim 1, wherein the guard member includes a plurality of teeth along at least one edge.

3. A cutting tool as set forth in claim 2, wherein the teeth are angled away from the curved portion of the guard member and, when engaged with a surface of associated vegetation, tend to resist sliding movement of the tool relative to the associated vegetation.

4. A cutting tool as set forth in claim 1, further comprising a biasing member for biasing the guard member towards the first position.

5. A cutting tool as set forth in claim 4, wherein the biasing member includes a spring.

6. A cutting tool as set forth in claim 1, wherein the motor is at least one of an electric motor, a pneumatic motor, or a hydraulic motor.

7. A cutting tool as set forth in claim 1, further comprising a handle removably attachable to the housing.

8. A cutting tool as set forth in claim 1, further comprising a shield member removably attachable to the housing and configured to at least partially surround the associated cutting bit when the associated bit is operatively connected to the output shaft.

9. A cutting tool as set forth in claim 8, wherein the shield member includes a concave surface facing the associated cutting bit when the associated bit is operatively connected to the output shaft.

10. A cutting tool as set forth in claim 1, wherein the motor is an electric motor, and further comprising a battery operatively connected to the electric motor for supplying electric power thereto.

11. A cutting tool as set forth in claim 10, wherein the housing includes a pistol grip, and further comprising a trigger switch operative to control the motor.

12. A cutting tool as set forth in claim 1, further comprising a rotary cutting bit selectively connected to the output shaft.

13. A cutting tool for cutting vegetation comprising:
a housing;
a motor supported within the housing;
an output shaft operatively connected to the motor for rotating an associated rotary cutting bit;
a power source operatively connected to the motor for supplying power to the motor; and
first and second spaced apart bit supports for supporting the associated rotary cutting bit for rotation at spaced apart locations along a longitudinal axis of the associated rotary cutting bit, at least one of the bit supports being supported by the housing.

14. A cutting tool as set forth in claim 13, wherein at least one of the bit supports includes a collet for engaging a shank of the associated rotary cutting bit, the collet being fixed for rotation with the output shaft.

15. A cutting tool as set forth in claim 13, wherein the at least one bit support supported by the housing includes a bit support arm secured to the housing.

16. A cutting tool as set forth in claim 13, further comprising a guard member attached to the housing and extending in a common direction with the output shaft, the guard member having two side portions and a curved portion forming a general U-shape, at least one of the side portions being pivotally attached to the housing, wherein the guard member is pivotable between a first position whereat each side portion of the guard member extends generally parallel and spaced apart from a longitudinal axis of the output shaft, and a second position whereat each side portion of the guard member extends generally non-parallel and spaced apart from the longitudinal axis of the output shaft, whereby when an associated rotary cutting bit is operatively connected to the output shaft, the sides of the U-shape guard, when in the first position, extend along a length of the associated rotary cutting bit.

17. A cutting tool as set forth in claim 15, including the rotary cutting bit.

18. A cutting tool as set forth in claim 17, wherein the bit support arm extends from the housing generally parallel with the rotary cutting bit, and wherein the bit support arm has a thickness that is at least as large as the diameter of the rotary cutting bit such that the bit support arm can acts as a spreader for a cut made in associated vegetation by the rotary cutting bit.

19. A cutting tool as set forth in claim 13, wherein at least one of the bit supports includes a bearing for supporting the associated rotary cutting bit for rotation.

20. A cutting tool as set forth in claim 13, wherein the housing includes a pistol grip portion, and further comprises a trigger switch operative to control the electric motor.
